(19) United States
(12) Patent Application Publication
(10) Pub. No.: US 2026/0039764 A1
(43) Pub. Date: Feb. 5, 2026

(54) IMAGE PROCESSING METHOD, APPARATUS, DEVICE, MEDIUM AND PROGRAM PRODUCT

(71) Applicant: Beijing Zitiao Network Technology Co., Ltd., Beijing (CN)

(72) Inventors: Qinggai Huang, Beijing (CN); Wei Yu, Beijing (CN); Maoliang Gong, Beijing (CN)

(21) Appl. No.: 19/203,579

(22) Filed: May 9, 2025

(30) Foreign Application Priority Data
Jul. 31, 2024 (CN) 202411047577.8

(51) Int. Cl. H04N 5/262

(52) U.S. Cl. CPC H04N 5/262

(57) ABSTRACT

A method comprises: displaying a target image and an effect control on a target interface; determining a target effect mode in response to interaction with the effect control, wherein the target effect mode represents an effect to be added to the target image, wherein the effect comprises a static effect without changing target image position information and a dynamic effect with changing target image position information, and for target static effect and target dynamic effect that have an associated relationship, the target dynamic effect is adjacent to the target static effect in an order of addition, and the target dynamic effect is added after the target static effect; and displaying the image processed with effect on the target interface, wherein the image processed with effect is obtained by adding static effect and dynamic effect corresponding to the target effect mode to the target image.

### CROSS-REFERENCE TO RELATED APPLICATION(S)

This application claims priority to Chinese Application No. 202411047577.8 filed Jul. 31, 2024, the disclosure of which is incorporated herein by reference in its entirety.

### FIELD

The present disclosure relates to the field of image rendering technology, and in particular to an image processing method, apparatus, device, medium and program product.

### BACKGROUND

An image effect refers to the artistic or technical processing of original images (such as original video images or local images) to achieve the purpose of enhancing visual effect and improving user experience.

### SUMMARY

In view of this, the present disclosure provides an image processing method, an image processing apparatus, an electronic device, a computer-readable storage medium, and a computer program product, which can improve the fitting degree between multiple effects.

In a first aspect, the present disclosure provides an image processing method, the method comprising:
displaying a target image and an effect control on a target interface;
in response to an interaction with the effect control, determining a target effect mode, the target effect mode represents the effect to be added to the target image, the effect includes a static effect that does not need to change position information of the target image and a dynamic effect that needs to change the position information of the target image, and for a target static effect and a target dynamic effect that have an associated relationship, the target dynamic effect is adjacent to the target static effect in an adding order, and the target dynamic effect is added after the target static effect;
displaying an image after effect processing on the target interface, the image after effect processing is obtained by adding the static effect and the dynamic effect corresponding to the target effect mode to the target image.

In a second aspect, the present disclosure provides an image processing apparatus, the apparatus comprising:
a first display module, configured to display a target image and an effect control on a target interface;
an effect processing module, configured to determine a target effect mode in response to an interaction with the effect control, wherein the target effect mode represents an effect to be added to the target image, the effect includes a static effect that does not require changing the position information of the target image and a dynamic effect that requires changing the position information of the target image, and for a target static effect and a target dynamic effect that have an associated relationship, a target dynamic effect is adjacent to the target static effect in an adding order, and the target dynamic effect is added after the target static effect;
a second display module, configured to display an image after effect processing on the target interface, and the image after effect processing is obtained by adding the static effect and the dynamic effect corresponding to the target effect mode to the target image.

In a third aspect, the present disclosure provides an electronic device, comprising: a memory and a processor, wherein the memory and the processor are communicatively connected to each other, the memory stores computer instructions, and the processor executes the above method by executing the computer instructions.

In a fourth aspect, the present disclosure provides a computer-readable storage medium having computer instructions stored thereon, the computer instructions being configured to enable a computer to execute the above method.

In a fifth aspect, the present disclosure provides a computer program product, including computer instructions, and the computer instructions are configured to enable a computer to execute the above method.

In some embodiments of the present disclosure, the target dynamic effect and target static effect with an associated relationship are added in an adjacent order, and the target dynamic characteristics are added after the target static characteristics. In this way, when the target dynamic characteristics are executed, the target static characteristics associated with the target dynamic characteristics have been added to the target image, so that in the process of executing the target dynamic characteristics, the action area of the target static characteristics in the target image will also be updated synchronously, so that the target static characteristics fit the target dynamic characteristics, which improves the fitting degree between different effects.

### BRIEF DESCRIPTION OF THE DRAWINGS

In order to more clearly illustrate the specific embodiments of the present disclosure or the technical solutions in the related technologies, the drawings required for use in the specific embodiments or the related technical descriptions will be briefly introduced below. Obviously, the drawings described below are some embodiments of the present disclosure. For ordinary technicians in this field, other drawings can be obtained based on these drawings without paying any creative work.

FIG. 1 is a schematic diagram of module interaction of image effect rendering in some technologies;

FIG. 2 is a schematic diagram of a process of rendering image effect in FIG. 1;

FIG. 3 is a schematic diagram showing the mismatch between static effect and dynamic effect in some technologies;

FIG. 4 is a schematic diagram of a process of an image processing method provided by an embodiment of the present disclosure;

FIG. 5 is a schematic diagram of a target interface provided by an embodiment of the present disclosure;

FIG. 6 is a schematic diagram of a target rendering chain provided by an embodiment of the present disclosure;

FIG. 7 is a module schematic diagram of an image processing apparatus provided by some embodiments of the present disclosure;

FIG. 8 is a schematic diagram of the structure of an electronic device provided by some embodiments of the present disclosure.

### DETAILED DESCRIPTION OF EMBODIMENTS

At present, some technologies can support adding multiple effects to an image at the same time, such as adding lipstick, smile and blush to a face in an image. However, the fitting degree of these multiple effects is still lacking. For example, after adding a smile, the lipstick is misplaced and cannot fit the smiling lips completely.

Therefore, a method for improving the fitting degree of effect is urgently needed.

In order to make the purpose, technical solution and advantages of the embodiments of the present disclosure clearer, the technical solution in the embodiments of the present disclosure will be clearly and completely described below in conjunction with the drawings in the embodiments of the present disclosure. Obviously, the described embodiments are part of the embodiments of the present disclosure, rather than all the embodiments. Based on the embodiments in the present disclosure, all other embodiments obtained by those skilled in the art without creative work are within the scope of protection of the present disclosure.

Embodiments of the present disclosure will be described in more detail below with reference to the accompanying drawings. Although certain embodiments of the present disclosure are shown in the accompanying drawings, it should be understood that the present disclosure can be implemented in various forms and should not be construed as being limited to the embodiments set forth herein. On the contrary, these embodiments are provided to provide a more thorough and complete understanding of the present disclosure. It should be understood that the drawings and embodiments of the present disclosure are only for exemplary purposes and are not intended to limit the scope of protection of the present disclosure.

In the description of the embodiments of the present disclosure, the term “including” and similar terms should be understood as open inclusion, that is, “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below.

Herein, unless explicitly stated, executing a step “in response to A” does not mean executing the step immediately after “A” but may include one or more intermediate steps.

It is understandable that the data involved in this technical solution (including but not limited to the data itself, the acquisition, use, storage or deletion of the data) shall comply with the requirements of relevant laws, regulations and relevant provisions.

It is understandable that before using the technical solutions disclosed in the various embodiments of the present disclosure, the types, scopes of use, usage scenarios, etc. of the information involved in the present disclosure should be informed to relevant users and their authorization should be obtained in an appropriate manner in accordance with relevant laws and regulations. The relevant users may include any type of right holders, such as individuals, enterprises, and groups.

For example, in response to receiving an active request from a user, a prompt message is sent to the relevant user to clearly prompt the relevant user that the operation requested to be performed will require obtaining and using the information of the relevant user, so that the relevant user can independently choose whether to provide information to software or hardware such as an electronic device, application, server or storage medium that executes the operation of the technical solution of the present disclosure based on the prompt message.

As an optional but non-limiting implementation, in response to receiving an active request from a relevant user, a prompt message is sent to the relevant user, for example, in the form of a pop-up window, in which the prompt message may be presented in text form. In addition, the pop-up window may also carry a selection control for the user to select “agree” or “disagree” to provide information to the electronic device.

It is understandable that the above notification and the process of obtaining user authorization are merely illustrative and do not constitute a limitation on the implementation of the present disclosure. Other methods that meet relevant laws and regulations may also be applied to the implementation of the present disclosure.

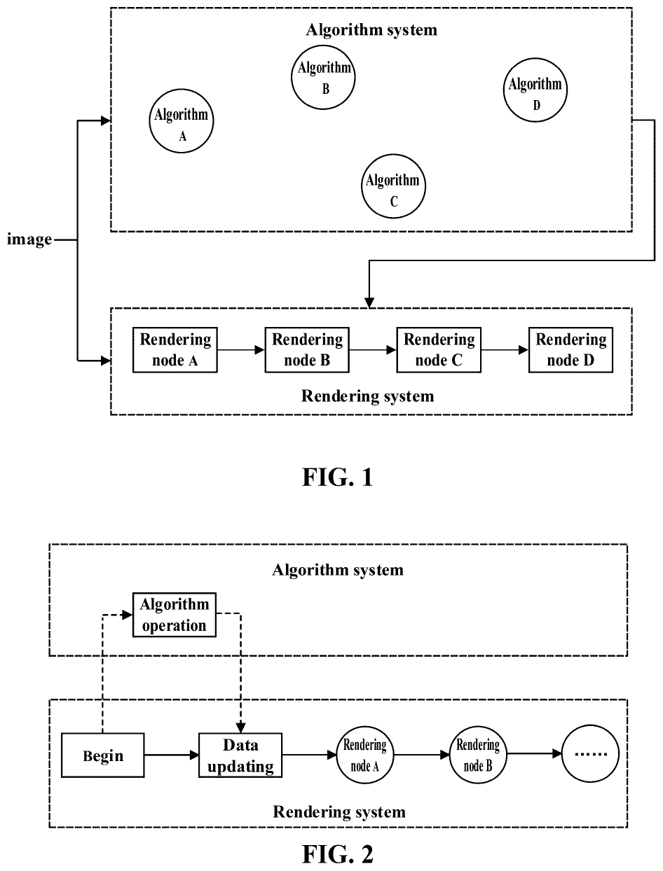

Please refer to FIG. 1 and FIG. 2. In some technologies, one or more effect processing can be performed on the image based on the algorithm system and the rendering system at the same time, and one or more effect can be added to the image.

Specifically, the rendering system can be used to perform static effect processing on the image and add static effect to the image. The so-called static effect processing refers to effect processing in which the position information of the image does not change, wherein position information includes the position information of key points. For example, when adding effect such as lipstick and blush to the face in the image, since the shapes of various parts of the face have not changed (that is, the position information of various parts of the face has not changed), these effects processing can be called static effect processing. In FIG. 1 and FIG. 2, each rendering node can perform different static effect processing in the image in sequence, and the output of the previous rendering node serves as the input of the next rendering node. For example, rendering node A can be used to add lipstick in the image, and rendering node B can be used to continue adding blush in the image after the lipstick is added. In this way, multiple static effects can be added in an image at the same time.

The algorithm system can run multiple algorithms, some of which can be used to perform dynamic effect processing on images and add dynamic effect in the image. The so-called dynamic effect processing refers to effect processing in which the position information of the image changes. For example, when the person in the image is not smiling, the person can be transformed into a smiling state through effect processing. Since the shape of the person's mouth is different in the two states of not smiling and smiling (that is, the position information of the person's mouth has changed), this effect processing can be called dynamic effect processing.

Other algorithms in the algorithm system can be used to extract basic information required for static effect processing from images before performing static effect processing on the images. For example, when adding lipstick to a face in an image, it is necessary to first run a detection algorithm to detect the position information of the face, so as to obtain the position information of the lips in the image.

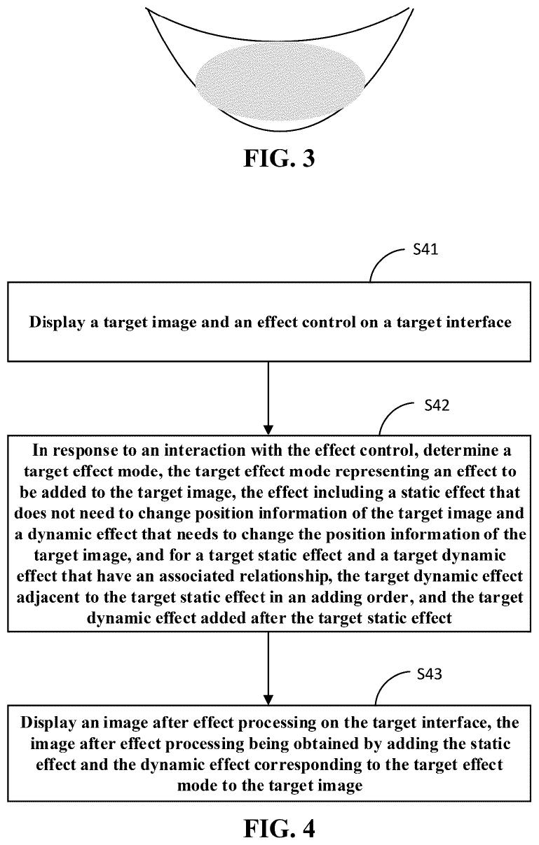

At present, in some technologies, when performing effect processing on an image, the algorithm is usually run in the algorithm system first, and after obtaining the dynamic effect processing result of the image and the basic information required for static effect processing, continue to perform static effect processing on the image that has completed the dynamic effect processing in the rendering system. A problem with this is that in the algorithm system, all algorithms take the original image as input, and when the rendering system continues to perform static effect processing on the image after the dynamic effect processing is completed based on the basic information extracted from the original image, there will be a phenomenon that the static effect and the dynamic effect will not fit together. For example, suppose that during the algorithm operation process of the algorithm system, the person in the original image is adjusted from a non-smiling state to a smiling state, and at the same time, the facial position information of the person in the non-smiling state is extracted from the original image. When the rendering system continues to add lipstick in the image with the smiling effect added based on the facial position information of the person in the non-smiling state, there will be a phenomenon that the static effect and the dynamic effect will not fit together as shown in FIG. 3. In FIG. 3, it is assumed that the shadow area is the mouth area determined based on the facial position information extracted from the original image. However, after adding the smile effect, the mouth area of the person is actually the area surrounded by black lines. This causes the problem of mismatch between static and dynamic effect.

In view of this, the present disclosure provides an image processing method that can solve the above problems and improve the fitting degree between multiple effects. The image processing method can be applied to electronic devices. Electronic devices include but are not limited to tablet computers, laptop computers, desktop computers, servers, etc. Referring to FIG. 4, a schematic diagram of a process of an image processing method provided by an embodiment of the present disclosure is shown. In FIG. 4, the image processing method comprises the following steps:

Step S41: A target image and effect controls are displayed on a target interface.

Specifically, the target image can be a video frame image during video playback, an image stored locally in an electronic device, etc. The target interface may be an interface of application software that supports image effect processing, such as a video playback interface of a video playback software, a software interface of an image editing software, etc. Referring to FIG. 5, a schematic diagram of a target interface 500 provided in accordance with an embodiment of the present disclosure is shown. In FIG. 5, the target interface 500 includes an image display area 51 and an effect control area 52. The effect control area 52 may include one or more effect controls 53. The effect controls may be used to characterize a set of one or more effect. The effect sets represented by different effect controls 52 may be different, such as an effect set characterized by effect control A may include smile+lipstick, and an effect set characterized by effect control B may include smile+lipstick+blush. Each effect control 52 may have its own associated program code. When an effect control 52 is selected, the program code associated with the effect control 52 may be run, and during the execution of the program code, the effect characterized by the effect control 52 may be added in the target image.

Step S42: In response to the interaction with the effect control, a target effect mode is determined, the target effect mode characterizes the effect to be added in the target image, the effect includes static effect that do not require changing the target image position information and dynamic effect that require changing the target image position information, and for target static effect and target dynamic effect that have an associated relationship, the target dynamic effect are adjacent to the target static effect in an adding order, and the target dynamic effect are added after the target static effect.

Specifically, for any dynamic effect A and any static effect B, after adding the dynamic effect A in the target image, if it will change the action area of static effect B in the target image, then the dynamic effect A and static effect B can be considered as target static effect and target dynamic effect with an associated relationship; conversely, after adding dynamic effect A in the target image, if it will not change the action area of static effect B in the target image, then the dynamic effect A and static effect B are not target static effect and target dynamic effect with an associated relationship.

For example, for smile effect and lipstick effect. After adding a smile effect to the person in the target image, the person's mouth position information will be changed, and then the action area of the lipstick effect in the target image will be changed. Therefore, the smile effect and the lipstick effect are target static effect and target dynamic effect with an associated relationship. For another example, for smile effect and eye shadow effect. After adding a smile effect to the person in the target image, although the person's mouth position information is changed, the person's eye position information is not changed, that is, the action area of the eye shadow effect in the target image is not changed. Therefore, the smile effect and the eye shadow effect can be considered as target static effect and target dynamic effect without an associated relationship.

Generally, the action areas of the target static effect and the target dynamic effect in the target image may be completely or partially overlapped.

In this embodiment, the target dynamic effect and the target static effect are added in an adjacent order, and the target dynamic characteristics are added after the target static characteristics. In this way, when the target dynamic characteristics are added, the action area of the target static characteristics will also be changed accordingly, so that the target static characteristics fit the target dynamic characteristics. For example, take the smile effect and the lipstick effect as an example. After adding the lipstick effect first, when adding the smile effect, the action area of the lipstick will also change, so that the action area of the lipstick is consistent with the action area of the smile, thereby improving the fitting degree between the lipstick effect and the smile effect.

In short, in step S42 of the present disclosure, the associated target dynamic effect and target static effect are added crosswise, while in some technologies, static effect are added after all dynamic effect are added. The present disclosure can effectively solve the problem of mismatch between dynamic effect and static effect in some technologies by crosswise adding static effect and dynamic effect.

It should be noted that, for dynamic effect and static effect that have no associated relationship, the effect can still be added in the order of adding the dynamic effect first and then adding the static effect.

Step S43: The image after effect processing is displayed on the target interface, the image after effect processing is obtained by adding static effect and dynamic effect corresponding to the target effect mode to the target image.

In summary, in some embodiments of the present disclosure, the target dynamic effect and target static effect with an associated relationship are added in an adjacent order, and the target dynamic characteristics are added after the target static characteristics. In this way, when the target dynamic characteristics are executed, the target static characteristics associated with the target dynamic characteristics have been added to the target image, so that in the process of executing the target dynamic characteristics, the action area of the target static characteristics in the target image will also be updated synchronously, so that the target static characteristics fit the target dynamic characteristics, which improves the fitting degree between different effects.

In addition, in the method disclosed herein, in the process of crosswise adding target static effect and target dynamic effect, the difficulty of implementing the solution can be effectively reduced by first adding the target static effect and then adding the target dynamic effect. Specifically, after adding the target static effect, the process of adding the target dynamic effect may not be affected, so that there is no need to improve the algorithm for adding dynamic effect, and there is no need to perform additional operations. However, if the target dynamic effect are added first, and then the target static effect associated with the target dynamic effect are added, the position information of the target image will change, and then when adding the target static effect, the position information of the target image may be detected again, which increases the complexity of the solution.

In some embodiments, static effect and dynamic effect are rendered into the target image through one or more rendering operations. After determining the target effect mode in the above step S41, the method of the present disclosure may further comprise:
determining, according to the target effect mode, an operation sequence of rendering operations to be performed on the target image, wherein the rendering operations include a static rendering operation for adding a static effect and a dynamic rendering operation for adding a dynamic effect, and, for a target dynamic rendering operation for adding a target dynamic effect and a target static rendering operation for adding a target static effect, the target dynamic rendering operation and the target static rendering operation are adjacent, and the target dynamic rendering operation is located after the target static rendering operation; and
performing the rendering operations on the target image in sequence in the order of operations.

Specifically, each rendering operation can be used to add an effect, respectively, for example, rendering operation A is used to add a smile effect, and rendering operation B is used to add a lipstick effect. Each rendering operation can generate one or more rendering instructions, and when these rendering instructions are executed, corresponding effect can be added in the target image.

The operation sequence of rendering operations can be specified in the program code corresponding to the target effect mode. By executing the program code, effect can be added to the target image in sequence in the specified order.

In the above embodiment, by specifying the operation sequence of the rendering operation, the order of adding static effect and dynamic effect can be controlled, so that the target dynamic rendering operation can be executed after the target static rendering operation, thereby improving the fitting between different effects.

In some embodiments, the above-mentioned determining the operation sequence of rendering operations to be performed on the target image according to the target effect mode may comprise:
determining a target rendering chain corresponding to a target effect mode, the target rendering chain including first rendering nodes corresponding one-to-one to static rendering operations and operation scripts corresponding one-to-one to dynamic rendering operations; and
determining the operation sequence of the rendering operation according to the sequence of the first rendering node and the operation script in the target rendering chain.

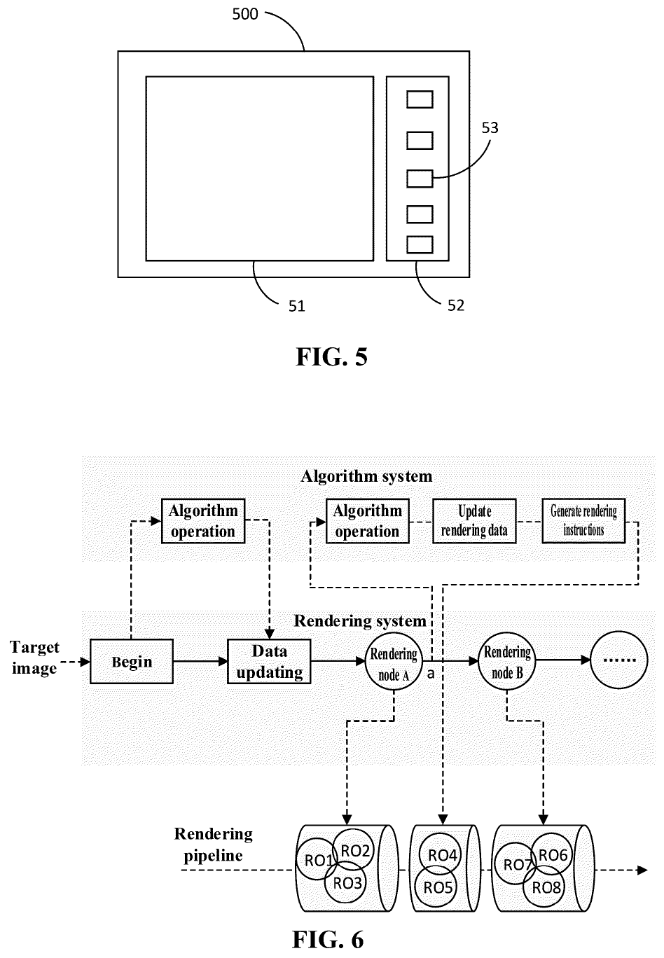

Specifically, the target rendering chain can be set in the program code associated with the target effect mode. Referring to FIG. 6, a schematic diagram of a target rendering chain provided by an embodiment of the present disclosure is shown. In FIG. 6, rendering node A, rendering node B, . . . are first rendering nodes corresponding to static rendering operations, and the link formed by the dotted line from point a upwards can represent an operation script corresponding to a dynamic rendering operation. Based on FIG. 6, the process of adding effect to the target image can be as follows:
1) The target image is input into the rendering system;
2) The rendering system calls the algorithm system to run the algorithm and obtain the relevant data required for rendering. Specifically, in this step, the following steps can be performed:
21) Running the detection algorithm in the algorithm system to obtain the position information of the target image;
22) For dynamic effect that are not associated with static effect, running algorithms related to these dynamic effects in the algorithm system to add these dynamic effects to the target image. It should be noted that for target dynamic effect associated with target static effect, the algorithm will not be run in this step to add these target dynamic effects in the target image.
3) By means of data updating, the target image after completing the addition of dynamic effect and the obtained related data (such as the position information of the target image) are updated to the rendering system.
4) Based on the data obtained from the algorithm system, the rendering system continues to add target static effect, target dynamic effect and other static effect other than the target static effect in the target image after completing the addition of dynamic effect. Specifically, in FIG. 6, each first rendering node in the target rendering chain may include a static rendering program code, and the static rendering program codes in different first rendering nodes may be different. For any first rendering node, when the static rendering program code in the first rendering node is run, the static rendering operation corresponding to the first rendering node may be performed to add a static effect to the target image. At the same time, each operation script in the target rendering chain may include a dynamic rendering program code, and the dynamic rendering program codes in different operation scripts may be different. For any operation script, when the dynamic rendering program code in the operation script is run, the dynamic rendering operation corresponding to the operation script may be performed to add a dynamic effect to the target image.

Based on the above description, it can be understood that by analyzing the target static effect, the target dynamic effect and other static effect other than the target static effect, by reasonably setting the positions of each first rendering node and the operation script in the target rendering chain, and then executing the program codes in each first rendering node and the operation script in sequence in the direction indicated by the arrows between the first rendering nodes in FIG. 6, the operation sequence of the rendering operation can be controlled.

Specifically, when the static rendering program code in the first rendering node is run to execute the static rendering operation corresponding to the first rendering node, or when the dynamic rendering program code in the operation script is run to execute the dynamic rendering operation corresponding to the operation script, one or more rendering instructions (such as RO1) can be generated. After these rendering instructions enter the rendering pipeline and are executed, corresponding static effect or dynamic effect can be generated on the target image.

In the above embodiment, by adjusting the positions of the first rendering node and the operation script in the target rendering chain, the operation sequence of the rendering operation can be controlled, and the control method of the operation sequence is relatively flexible.

In some embodiments, the target rendering chain may be established based on the following method:
The first rendering nodes are sorted to obtain an initial rendering chain;
After mounting the target operation script corresponding to the target dynamic rendering operation to the first rendering node corresponding to the target static rendering operation, a target rendering chain is obtained.

For example, assuming that the target static rendering operation is used to render the lipstick effect, the target dynamic rendering operation is used to render the smile effect, and the first rendering node corresponding to the target static rendering operation is the rendering node A in FIG. 6, then the target operation script corresponding to the target dynamic rendering operation can be mounted after the rendering node A. In this way, when the program codes in each first rendering node and the operation script are executed in sequence, the smile effect can be controlled to be added after the lipstick effect.

In some embodiments, the above-mentioned after mounting the target operation script corresponding to the target dynamic rendering operation to the first rendering node corresponding to the target static rendering operation may comprise:
searching for a target rendering node after a first rendering node corresponding to a target static rendering operation in the initial rendering chain;
mounting the target operation script to the target rendering node, wherein, in the case that the target operation script is mounted to the target rendering node, the position of the target operation script in the target rendering chain is located before the target rendering node.

For example, taking the example of mounting the target operation script corresponding to the target dynamic rendering operation to the rendering node A in the previous embodiment. Specifically, the target operation script corresponding to the target dynamic rendering operation can be mounted to the rendering node B after the rendering node A. After the static rendering program code in the rendering node A has been run and completed, the dynamic rendering program code in the operation script mounted to the rendering node B can be run first, and then the static rendering program code in the rendering node B can be run. In this way, it is ensured that the target dynamic effect can be added between the rendering node A and the rendering node A.

In the above embodiment, the target operation script is mounted to the target rendering node after the first rendering node corresponding to the target static rendering operation, so there is no need to create a rendering node separately for the operation script, thereby reducing the number of rendering nodes in the target rendering chain.

In some embodiments, if the target rendering operation is not found in the initial rendering chain, a second rendering node is added after the first rendering node corresponding to the target static rendering operation, and the target operation script can be mounted to the second rendering node.

Specifically, the second rendering node may not have static rendering program code, and is only used to mount the target operation script, so as to ensure that the target operation script has a mounting point in the target rendering chain.

In some embodiments, the storage path of the target operation script can be written into the node attribute of the target rendering node. In this way, when the dynamic rendering program code in the target operation script needs to be executed, the target operation script can be obtained from the corresponding storage path. In this way, the amount of mounted data is reduced.

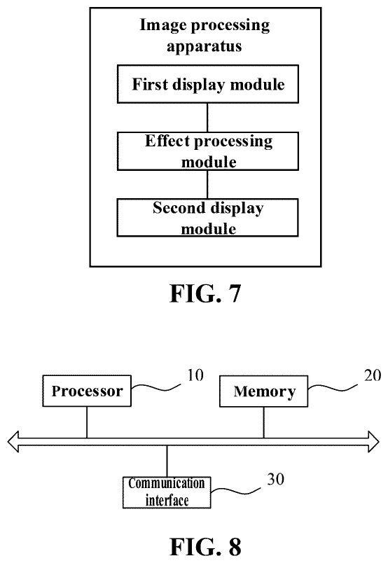

Corresponding to the image processing method, the present disclosure also provides an image processing apparatus. Referring to FIG. 7, a module schematic diagram of an image processing device provided by some embodiments of the present disclosure is shown. In FIG. 7, the image processing device comprises:
a first display module, configured to display a target image and an effect control on a target interface;
an effect processing module, configured to determine a target effect mode in response to an interaction with the effect control, the target effect mode represents an effect to be added to a target image, the effect includes a static effect that does not require changing position information of the target image and a dynamic effect that requires changing the position information of the target image, and for a target static effect and a target dynamic effect that have an associated relationship, the target dynamic effect is adjacent to the target static effect in an adding order, and the target dynamic effect is added after the target static effect;
a second display module, configured to display an image after effect processing on the target interface, the image after effect processing is obtained by adding the static effect and the dynamic effect corresponding to the target effect mode to the target image.

In some embodiments, static effect and dynamic effect are rendered into a target image through one or more rendering operations; after determining the target effect mode, the effect processing module is further configured to:
determine, according to the target effect mode, an operation sequence of rendering operations to be performed on the target image, wherein the rendering operations include a static rendering operation for adding a static effect and a dynamic rendering operation for adding a dynamic effect, and, for a target dynamic rendering operation for adding a target dynamic effect and a target static rendering operation for adding a target static effect, the target dynamic rendering operation and the target static rendering operation are adjacent, and the target dynamic rendering operation is located after the target static rendering operation;
perform the rendering operations on the target image in sequence in the order of operations.

In some embodiments, the effect processing module is specifically configured to:
determine a target rendering chain corresponding to a target effect mode, the target rendering chain includes first rendering nodes corresponding one-to-one to static rendering operations and operation scripts corresponding one-to-one to dynamic rendering operations;
determine the operation sequence of the rendering operations according to the sequence of the first rendering node and the operation script in the target rendering chain.

In some embodiments, the effect processing module is specifically configured to establish a target rendering chain based on the following method:
the first rendering nodes are sorted to obtain an initial rendering chain;

After mounting the target operation script corresponding to the target dynamic rendering operations to the first rendering node corresponding to the target static rendering operation, a target rendering chain is obtained.

In some embodiments, the effect processing module is specifically configured to:
search for a target rendering node after a first rendering node corresponding to a target static rendering operation in the initial rendering chain;
mount the target operation script to the target rendering node, wherein, in the case that the target operation script is mounted to the target rendering node, the position of the target operation script in the target rendering chain is located before the target rendering node.

In some embodiments, the effect processing module is specifically configured to:
if the target rendering operation is not found in the initial rendering chain, then add a second rendering node after the first rendering node corresponding to the target static rendering operation;
mount the target operation script to the second rendering node.

In some embodiments, the effect processing module is specifically configured to:
write the storage path of the target operation script into the node properties of the target rendering node.

The configuration apparatus in this embodiment is presented in the form of a functional unit, where the unit refers to an ASIC (Application Specific Integrated Circuit) circuit, a processor and memory that executes one or more software or fixed programs, and/or other devices that can provide the above functions.

The image processing apparatus disclosed in the present invention has the same beneficial effect as the above-mentioned image processing method, which will not be described in detail here.

The embodiment of the present disclosure also provides an electronic device having the image processing apparatus shown in FIG. 7 above.

Referring to FIG. 8, a schematic diagram of the structure of an electronic device provided for some embodiments of the present disclosure is provided. As shown in FIG. 8, the electronic device comprises: one or more processors 10, a memory 20, and interfaces for connecting various components, including high-speed interfaces and low-speed interfaces. The various components are communicatively connected to each other using different buses, and can be installed on a common mainboard or installed in other ways as needed. The processor can process instructions executed in the electronic device, including instructions stored in or on the memory to display graphical information of the GUI on an external input/output apparatus (such as a display device coupled to the interface). In some optional embodiments, if necessary, multiple processors and/or multiple buses can be used together with multiple memories and multiple memories. Similarly, multiple electronic devices can be connected, and each device provides some necessary operations (for example, as a server array, a group of blade servers, or a multi-processor system). In FIG. 8, a processor 10 is taken as an example.

The processor 10 may be a central processing unit, a network processor or a combination thereof. The processor 10 may further include a hardware chip. The hardware chip may be a dedicated integrated circuit, a programmable logic device or a combination thereof. The programmable logic device may be a complex programmable logic device, a field programmable logic gate array, a general purpose array logic or any combination thereof.

Among them, the memory 20 stores instructions executable by at least one processor 10, so that the at least one processor 10 executes the method shown in the above embodiment.

The memory 20 may include a program storage area and a data storage area, wherein the program storage area may store an operating system, an application required for at least one function; the data storage area may store data created according to the use of the electronic device, etc. In addition, the memory 20 may include a high-speed random access memory, and may also include a non-transient memory, such as at least one disk storage device, a flash memory device, or other non-transient solid-state storage device. In some optional embodiments, the memory 20 may optionally include a memory remotely set relative to the processor 10, and these remote memories may be connected to the electronic device via a network. Examples of the above-mentioned network include, but are not limited to, the Internet, an intranet, a local area network, a mobile communication network, and combinations thereof.

The memory 20 may include a volatile memory, such as a random access memory; the memory may also include a non-volatile memory, such as a flash memory, a hard disk or a solid state drive; the memory 20 may also include a combination of the above types of memory.

The electronic device further comprises a communication interface 30 for the electronic device to communicate with other devices or a communication network.

The embodiment of the present disclosure also provide a computer-readable storage medium. The above-mentioned method according to the embodiments of the present disclosure can be implemented in hardware, firmware, or can be implemented as a computer code that can be recorded in a storage medium, or can be implemented as a computer code that is originally stored in a remote storage medium or a non-temporary machine-readable storage medium and will be stored in a local storage medium and downloaded through a network, so that the method described herein can be processed by these software stored in a storage medium using a general-purpose computer, a dedicated processor, or programmable or dedicated hardware. Among them, the storage medium can be a magnetic disk, an optical disc, a read-only storage memory, a random access memory, a flash memory, a hard disk or a solid-state disk, etc.; further, the storage medium can also include a combination of the above-mentioned types of memory. It can be understood that a computer, a processor, a microprocessor controller, or programmable hardware includes a storage component that can store or receive software or computer code. When the software or computer code is accessed and executed by a computer, a processor, or hardware, the method shown in the above embodiment is implemented.

Part of the present disclosure may be applied as a computer program product, such as a computer program instruction, which, when executed by a computer, can call or provide the method and/or technical solution according to the present disclosure through the operation of the computer. Those skilled in the art should understand that the existence of computer program instructions in computer-readable media includes, but is not limited to, source files, executable files, installation package files, etc., and accordingly, the way in which computer program instructions are executed by a computer includes, but is not limited to: the computer directly executes the instruction, or the computer compiles the instruction and then executes the corresponding compiled program, or the computer reads and executes the instruction, or the computer reads and installs the instruction and then executes the corresponding installed program. Here, the computer-readable medium can be any available computer-readable storage medium or communication medium accessible to the computer.

Although the embodiments of the present disclosure have been described in conjunction with the accompanying drawings, those skilled in the art may make various modifications and variations without departing from the spirit and scope of the present disclosure, and such modifications and variations are all within the scope defined by the appended claims.

I/We claim:

1. An image processing method, wherein the method comprises:
displaying a first image and an effect control on an interface;
in response to an interaction with the effect control, determining an effect mode, the effect mode representing an effect to be added to the image, the effect including a static effect that does not change position information of the image and a dynamic effect that changes the position information of the target image, and for a static effect and a dynamic effect that being associated with each other, the dynamic effect being adjacent to the static effect in an adding order, and the dynamic effect being added after the static effect; and
displaying a second image on the interface, the second image being obtained by adding, to the first image, a static effect and a dynamic effect corresponding to the effect mode.

2. The method according to claim 1, wherein the static effect and the dynamic effect are rendered into the image through one or more rendering operations;
after determining the effect mode, the method further comprises:
according to the effect mode, determining an operation sequence of rendering operations to be performed on the image, wherein the rendering operations include a static rendering operation for adding the static effect and a dynamic rendering operation for adding the dynamic effect, and, for a dynamic rendering operation for adding the dynamic effect and a static rendering operation for adding the static effect, the dynamic rendering operation is adjacent to the static rendering operation and the dynamic rendering operation is located after the static rendering operation; and
according to the operation sequence, performing the rendering operations on the image in sequence.

3. The method according to claim 2, wherein determining the operation sequence of the rendering operations to be performed on the image according to the effect mode comprises:
determining a rendering chain corresponding to the effect mode, the rendering chain including a first rendering node corresponding one-to-one to the static rendering operation, and an operation script corresponding one-to-one to the dynamic rendering operation; and
determining the operation sequence of the rendering operation according to a sequence of the first rendering node and the operation script in the rendering chain.

4. The method according to claim 3, wherein the rendering chain is established based on the following method:
sorting the first rendering node to obtain an initial rendering chain; and
after mounting a operation script corresponding to the dynamic rendering operation to the first rendering node corresponding to the static rendering operation, obtaining the rendering chain.

5. The method according to claim 4, wherein after mounting the operation script corresponding to the dynamic rendering operation to the first rendering node corresponding to the static rendering operation, the method comprises:
searching for a rendering node after the first rendering node corresponding to the static rendering operation in the initial rendering chain; and
mounting the operation script to the rendering node, wherein in response to the operation script being mounted to the rendering node, a position of the operation script in the rendering chain is located before the rendering node.

6. The method according to claim 5, wherein the method further comprises:
in response to not finding the rendering operation in the initial rendering chain, adding a second rendering node after the first rendering node corresponding to the static rendering operation; and
mount the operation script to the second rendering node.

7. The method according to claim 5, wherein mounting the operation script to the rendering node comprises:
writing a storage path of the operation script into a node attribute of the rendering node.

8. An electronic device, comprising:
a memory and a processor, wherein the memory and the processor are communicatively connected to each other, the memory stores computer instructions, and the computer instructions, when executed by the processor, cause the processor to:
display a image and an effect control on a interface;
in response to an interaction with the effect control, determine a effect mode, the effect mode representing an effect to be added to the image, the effect including a static effect that does not change position information of the image and a dynamic effect that change the position information of the image, and for a static effect and a dynamic effect that have an associated relationship, the dynamic effect being adjacent to the static effect in an adding order, and the dynamic effect being added after the static effect; and
display an image after effect processing on the interface, the image after effect processing being obtained by adding the static effect and the dynamic effect corresponding to the effect mode to the image.

9. The electronic device of claim 8, wherein the static effect and the dynamic effect are rendered into the image through one or more rendering operations; after determining the effect mode, the computer instructions further comprise instructions to:
according to the effect mode, determine an operation sequence of rendering operations to be performed on the image, wherein the rendering operations include a static rendering operation for adding the static effect and a dynamic rendering operation for adding the dynamic effect, and, for a dynamic rendering operation for adding the dynamic effect and a static rendering operation for adding the static effect, the dynamic rendering operation is adjacent to the static rendering operation and the dynamic rendering operation is located after the static rendering operation; and
according to the operation sequence, perform the rendering operations on the image in sequence.

10. The electronic device of claim 9, wherein the computer instructions causing the processor to determine the operation sequence of the rendering operations to be performed on the image according to the effect mode comprise instructions to:
determine a rendering chain corresponding to the effect mode, the rendering chain including a first rendering node corresponding one-to-one to the static rendering operation, and an operation script corresponding one-to-one to the dynamic rendering operation; and
determine the operation sequence of the rendering operation according to a sequence of the first rendering node and the operation script in the rendering chain.

11. The electronic device according to claim 10, wherein the rendering chain is established based on the method corresponding to the computer instructions to:
sort the first rendering node to obtain an initial rendering chain; and
after mounting a operation script corresponding to the dynamic rendering operation to the first rendering node corresponding to the static rendering operation, obtain the rendering chain.

12. The electronic device according to claim 11, after mounting the operation script corresponding to the dynamic rendering operation to the first rendering node corresponding to the static rendering operation, the computer instructions further comprise instructions to:
search for a rendering node after the first rendering node corresponding to the static rendering operation in the initial rendering chain; and
mount the operation script to the rendering node, wherein in response to the operation script being mounted to the rendering node, a position of the operation script in the rendering chain is located before the rendering node.

13. The electronic device according to claim 12, wherein the computer instructions further comprise instructions to:
in response to not finding the rendering operation in the initial rendering chain, add a second rendering node after the first rendering node corresponding to the static rendering operation; and
mount the operation script to the second rendering node.

14. The electronic device according to claim 12, wherein the computer instructions causing the processor to mount the operation script to the rendering node comprise instructions to:
write a storage path of the operation script into a node attribute of the rendering node.

15. A computer-readable non-transitory storage medium, wherein the computer-readable non-transitory storage medium having computer instructions stored thereon, and the computer instructions are configured to cause a computer to:
display a image and an effect control on a interface;
in response to an interaction with the effect control, determine a effect mode, the effect mode representing an effect to be added to the image, the effect including a static effect that does not change position information of the image and a dynamic effect that change the position information of the image, and for a static effect and a dynamic effect that have an associated relationship, the dynamic effect being adjacent to the static effect in an adding order, and the dynamic effect being added after the static effect; and
display an image after effect processing on the interface, the image after effect processing being obtained by adding the static effect and the dynamic effect corresponding to the effect mode to the image.

16. The electronic device of claim 15, wherein the static effect and the dynamic effect are rendered into the image through one or more rendering operations; after determining the effect mode, the computer instructions further comprise instructions to:
according to the effect mode, determine an operation sequence of rendering operations to be performed on the image, wherein the rendering operations include a static rendering operation for adding the static effect and a dynamic rendering operation for adding the dynamic effect, and, for a dynamic rendering operation for adding the dynamic effect and a static rendering operation for adding the static effect, the dynamic rendering operation is adjacent to the static rendering operation and the dynamic rendering operation is located after the static rendering operation; and
according to the operation sequence, perform the rendering operations on the image in sequence.

17. The electronic device of claim 16, wherein the computer instructions causing the computer to determine the operation sequence of the rendering operations to be performed on the image according to the effect mode comprise instructions to:
determine a rendering chain corresponding to the effect mode, the rendering chain including a first rendering node corresponding one-to-one to the static rendering operation, and an operation script corresponding one-to-one to the dynamic rendering operation; and
determine the operation sequence of the rendering operation according to a sequence of the first rendering node and the operation script in the rendering chain.

18. The electronic device according to claim 17, wherein the rendering chain is established based on the method corresponding to the computer instructions to:
sort the first rendering node to obtain an initial rendering chain; and
after mounting a operation script corresponding to the dynamic rendering operation to the first rendering node corresponding to the static rendering operation, obtain the rendering chain.

19. The electronic device according to claim 18, after mounting the operation script corresponding to the dynamic rendering operation to the first rendering node corresponding to the static rendering operation, the computer instructions further comprise instructions to:
search for a rendering node after the first rendering node corresponding to the static rendering operation in the initial rendering chain; and
mount the operation script to the rendering node, wherein in response to the operation script being mounted to the rendering node, a position of the operation script in the rendering chain is located before the rendering node.

20. The electronic device according to claim 19, wherein the computer instructions further comprise instructions to:
in response to not finding the rendering operation in the initial rendering chain, add a second rendering node after the first rendering node corresponding to the static rendering operation; and
mount the operation script to the second rendering node.
